(19) United States
(12) Patent Application Publication
(10) Pub. No.: US 2007/0184679 A1
(43) Pub. Date: Aug. 9, 2007

(54) ELECTRICAL CONTACT-MAKING APPARATUS AS WELL AS AN ELECTRICAL CONTACT-MAKING METHOD

(76) Inventor: Rainer Schmid, Pliezhausen (DE)

Correspondence Address: OSTROLENK FABER GERB & SOFFEN, 1180 AVENUE OF THE AMERICAS, NEW YORK, NY, 100368403, US

(21) Appl. No.: 11/672,221

(22) Filed: Feb. 7, 2007

(30) Foreign Application Priority Data
Feb. 7, 2006 (DE) 10 2006 005 522.5

(51) Int. Cl. H01R 12/00

(52) U.S. Cl. 439/66

(57) ABSTRACT

An electrical contact-making apparatus for testing electrical units, having at least one contact element which operates on the bent-wire principle and is guided such that it can move axially and can rotate in at least one guide hole of a guide device through which the contact element passes. The contact element has an offset at a location along its length and in the form of a side deflection which points in at least one first direction. The guide hole has at least one guide section which points in at least one lateral, second direction for the contact element, with the first direction including an angle (α) which is not equal to zero with respect the second direction. A corresponding method of operating the apparatus is disclosed.

### BACKGROUND OF THE INVENTION

The invention relates to an electrical contact-making apparatus for testing electrical units under test, having at least one contact element which operates on the bent-wire principle and is guided such that it can move axially and can rotate in at least one guide hole.

A contact-making apparatus of the type mentioned initially is known. This has two guide plates which are axially separated from one another and are provided with guide holes in which naturally elastic contact elements in the form of bent wires are located. For electrical testing of a unit under test, the contact ends of the contact elements are pushed against contact points on the unit under test, thus forming test current paths. When the contact elements are pushed against the unit under test, they spring out sideways so that, on the one hand, a contact force is in each case applied and, on the other hand, it is also possible to compensate for height differences. At their ends facing away from the unit under test, the contact elements are connected to an electrical test device. If there is any contamination on the contact points with the unit under test, for example as a result of an oxide layer being formed, the respective contact resistance may not be optimum.

### SUMMARY OF THE INVENTION

The invention is thus based on the object of providing an electrical contact-making apparatus of the type mentioned initially which, while being of simple design, always ensures that a very good electrical contact is made with the unit under test.

According to the invention, this object is achieved in that the contact element has an offset in the form of a lateral deflection which points in at least one first direction and in that the guide hole has at least one guide section which points in at least one lateral, second direction for the contact element, with the first direction including an angle which is not equal to zero with the second direction. A torque is exerted on the contact element by the lateral deflection of the contact element in the first direction and by the movement of the deflection in the second direction which takes place when contact is made with the unit under test, and this results in it rotating through a specific angle about its longitudinal axis. The self-initiated rotary movement of the contact element reduces the contact resistance with the unit under test, thus always making a good contact with the unit under test. This effectively results in a method of operation based on the crank principle, that is to say the movement of the deflection of the contact element takes place in a direction which does not correspond to the deflection direction but transversely to it, with the contact element being rotated “like a crank”, thus resulting in optimum electrical contact being made with the unit under test. Fine structures in particular, especially the testing of semiconductor modules (microchips) on wafers, can be tested easily and reliably, with a very good electrical contact, by means of the electrical contact-making apparatus according to the invention.

The invention also relates to an electrical contact-making apparatus for testing electrical units under test, having at least one contact element which operates on the bent-wire principle and is guided such that it can move axially and can rotate in at least one guide element, in which case the contact element has an offset in the form of a lateral deflection which points in at least one first direction, and in that the guide element can be moved in at least one lateral, second direction, with the first direction including an angle which is not equal to zero with the second direction. The movement of the guide element in a direction which does not correspond to the direction of the deflection, that is to say the curved shape, of the contact element, effectively results in a “crank force” being exerted on the contact element, causing it to rotate. Since force is applied axially to the contact element in order to make contact with the unit under test, a force is exerted on the guide element in the area of the deflection of the contact element, resulting in the guide element being moved in the second direction. In this case as well, this in consequence results in a rotary movement, which is initiated by the contact element itself, in order to improve the contact characteristics with the unit under test. The contact element is guided such that it can move axially and can rotate in the guide element—as already mentioned. In particular, the contact element, which is in the form of a pin, has a circular cross section, and the guidance in the contact element is provided by means of a guide hole with a circular cross section, with there being only a relatively small amount of movement play between the guide hole and the contact element.

One development of the invention provides that the guide element can be moved laterally by means of at least one guide section like a hole. The guide element, for example a guide plate, preferably has at least one guide section which is like a hole and through which a stationary guide means, for example a guide pin, passes. If the contact element exerts a lateral force on the guide element as a result of the contact made with the unit under test, then the guide element is moved correspondingly laterally as a result of the guide section/guide pin mounting that has been mentioned, driving the contact element (like a crank) in the process, and thus initiating the desired rotary movement.

One development of the invention provides that the guide section runs in a straight line, or does not run in a straight line. It is possible to provide for the guide section to run in a curved shape. It is also possible for the guide section to run in the form of an angle. Mixed forms are, of course, also feasible. In consequence, by way of example, a guide section has a part in the form of a straight line and a part which is adjacent to it and is curved or angled. Other combinations are also feasible.

One development of the invention provides that the offset of the contact element is provided by a specific structure, in particular a natural bend, of the contact element. If, in consequence, the contact element is not inserted into the test head, then this is subject to a lateral deflection even when no force is applied, that is to say to an offset. This results in natural bending of the contact element. Furthermore, the contact element is itself always intrinsically elastic, in order to apply the contact spring force.

Additionally or alternatively, it is possible to provide for the offset of the contact element to be produced by the influence of external force, in particular the influence of external lateral force and/or axial force, on the contact element. The influence of external lateral force leads to deflection of the elastic contact elements, and in consequence leads to the offset. However, additionally or alternatively, it is also possible to provide for the influence of the axial force, such as that which occurs in particular when contact is being made with the unit under test, to deflect the elastic contact element laterally, and for it to be provided with its lateral deflection in this way, forming the offset. The offset can also be produced by the contact element being guided in at least two guide holes which are at a distance from one another and are not aligned with one another, that is to say they are offset with respect to one another. This results in the contact element being correspondingly bent.

One development of the invention provides for that end of the contact element which faces away from the unit under test to be mounted such that it cannot move axially but can rotate. The axial force resulting from contact with the unit under test is in consequence absorbed by the mounting, which cannot move axially, at the end of the contact element, although it must still be possible for the contact element to rotate in order to allow the contact tips to be rotated in order to reduce the contact resistance with the unit under test.

The invention also relates to an electrical contact-making method for testing of electrical units under test, in particular for use with the contact-making apparatus described above, having at least one contact element which operates on the bent-wire principle and is mounted such that it can move axially and can rotate, in which case the contact element has an offset in the form of a lateral deflection, which points in at least one first direction, and is guided in the area of this deflection by the contact made with the unit under test, in such a manner that the deflection is moved in a second direction, which includes an angle which is not equal to zero with the first direction.

### BRIEF DESCRIPTION OF THE DRAWINGS

The drawings illustrate the invention with reference to exemplary embodiments, to be precise, in which case:

FIG. 1 shows an electrical contact-making apparatus in a unit under test with no contact having been made,

FIG. 2 shows the arrangement from FIG. 1 with contact having been made with the unit under test,

FIGS. 3 to 5 show various embodiments of guide sections for contact elements of the electrical contact-making apparatus,

FIG. 6 shows a guide element according to a further embodiment of the electrical contact-making apparatus, and

FIG. 7 shows an outline figure in order to explain the fundamental principle according to the invention.

### DESCRIPTION OF PREFERRED EMBODIMENTS

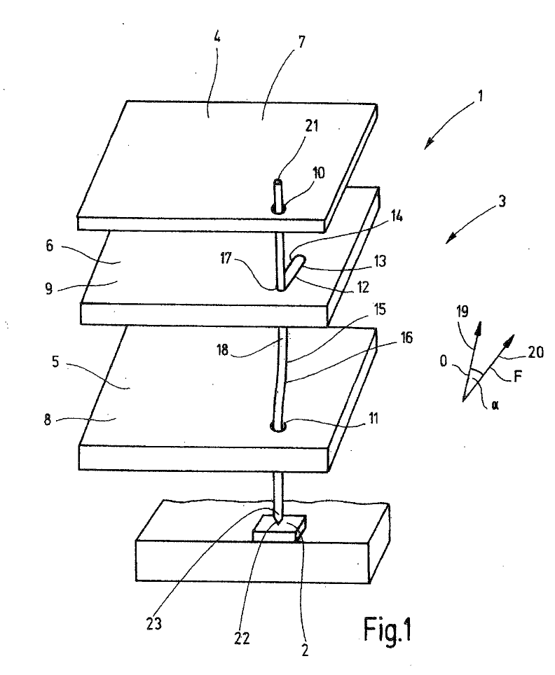

FIG. 1 shows a perspective view of a schematically illustrated electrical contact-making apparatus 1 for testing of an electrical unit under test 2. The electrical contact-making apparatus 1 has a test head 3, which has a first guide element 4 and a second guide element 5. A third guide element 6 for the test head 3 is arranged between the first and the second guide elements 4, 5. The guide elements 4 to 6 are respectively in the form of guide plates 7 to 9. The guide plates 7 to 9 run parallel to one another, separated axially.

The guide plate 7 has a circular guide hole 10, and the guide plate 8 has a circular guide hole 11. The guide plate 9 has a guide hole 12 which has a guide section 13, that is to say the hole does not have a circular shape but—in the exemplary embodiment in FIG. 1—is in the form of an elongated hole. The guide hole 12 together with the guide section 13 accordingly forms an elongated hole 14. A contact element 15 passes through the two guide holes 10 and 11 and the elongated hole 14, has a circular cross section and by virtue of its intrinsic elasticity forms a bent wire 16. When the contact element 15 is not inserted into the guide plates 7 to 9, its longitudinal extent has a linear profile.

The two guide holes 10 and 11 are aligned with one another. The end area 17 of the elongated hole 14 is not aligned with the two guide holes 10 and 11, which results in the inserted bent wire 16 being provided with a lateral deflection 18 with respect to its linear shape, that is to say it has an offset O. The direction of the offset O is represented by an arrow in FIG. 1. The arrow direction indicates the direction of the lateral deflection 18, pointing in a first direction 19. The longitudinal extent of the elongated hole 14 points in a second direction 20, that is to say the guide section 13 points in the direction 20, which is annotated by F in the figure.

As can be seen from FIG. 1, the first direction 19 includes an angle α which is not equal to zero with the second direction 20. In the present case, this is an acute angle.

The end 21 of the contact element 15 which faces away from the unit under test 2 is supported on an electrical opposing contact, which leads to a test device. The opposing contact and the test device are not illustrated, for the sake of simplicity. FIG. 1 shows only a single contact element 15 for the test head 3. Since, for example, the unit under test 2 may be a semiconductor module on a wafer, to which a large number of test currents must be applied for test purposes, the test head in practice has a large number of contact elements 15, which are all brought into contact with the unit under test at the same time. For this purpose, the unit under test 2 is moved relative to the test head 3 in such a manner that that end 23 of each contact element 15 which is preferably provided with a contact tip 22 is placed on the unit under test 2, resulting in an axial force being exerted on the respective contact element 15, causing it to bend away laterally on the basis of the bent-wire principle. Axial movement of the end 21 of the contact element 15 is prevented by means of the support on the object mentioned, against contact. However, the end 21 rests only on the opposing contact, that is to say the contact element 15 can rotate, as will be described in more detail in the following text.

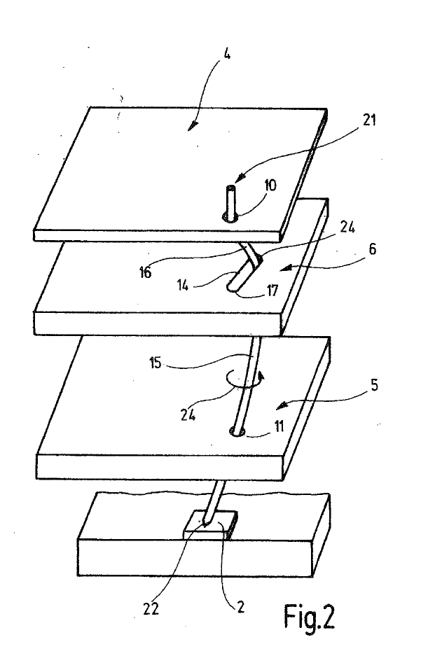

When the contact element 15 is deflected laterally by making contact with the unit under test, this takes place in a direction which differs from the direction of the offset O (first direction 19), since the bending direction is governed by the profile of the elongated hole 14, which points in the second direction 20. In consequence, as can be seen by comparing FIGS. 1 and 2, this results when contact is being made in the deflection 18 within the elongated hole 14 being moved from the end area 17 to the end area 24. Since the offset O in its first direction 19 differs from the profile of the elongated hole F (second direction 20), with this being represented by the angle α, the contact-making movement results in rotation 24 of the contact element 15 through a specific angle, resulting in this rotary movement also being carried out by the contact tip 22 that is pressed against the unit under test 2. This rotary movement leads to a very good electrical contact since, for example, this results in any oxide layers being passed through.

When the unit under test 2 is moved away from the test head 3 again, then the contact element 15 springs back to the previous position as in FIG. 1, with a reverse rotation taking place.

As is evident from the above explanation, the contact element 15 is deflected 18 in the form of an offset O as a result of the offset of the guide holes 10 to 12. In principle, it is also possible for this offset O to result from natural bending/natural curvature, that is to say by an intrinsic structure of the contact element itself, that is to say a contact element 15 which is not loaded, that is to say which has not been inserted into the test head 3, intrinsically has a profile which is not linear, for example a curved shape. The offset O can additionally or alternatively also be formed by applying external force laterally on the contact element 15, as results by way of example on the basis of the non-aligned position of the guide holes 10 to 12 in the exemplary embodiment shown in FIG. 1. However, other force influences are also feasible, which can cause a corresponding deflection 18. Alternatively or additionally, it is also possible for the deflection to be produced only when contact is made between the unit under test 2 and the contact element 15, that is to say the deflection is produced on the basis of the bent-wire principle (deflection by placing on the unit under test). In order to allow a rotary movement to take place while contact is being made in this case, it is necessary to guide the contact element 15 in a guide section 13 which does not point in the direction of the deflection 18, but differs from this direction. By way of example, this can be achieved by the elongated hole not being a straight elongated hole, but for example being a curved elongated hole.

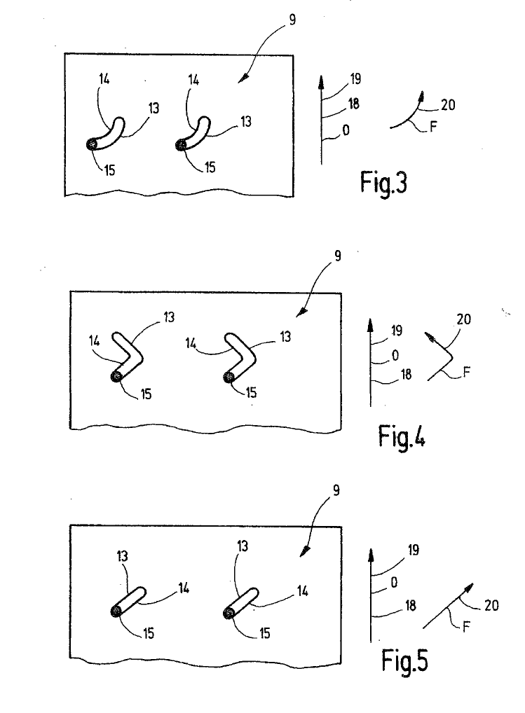

FIGS. 3 to 5 show various types of guide sections 13 in the form of elongated holes 14, which are designed to be curved, in particular banana-shaped or the like—irrespective of whether the deflection 18 is produced by natural curvature or by the application of external force.

FIGS. 4 and 5 show further elongated holes 14 which do not run in straight lines, that is to say the respective guide section 13 in FIG. 4 is angled, and is once again shown in the form of a straight line in FIG. 5—in order to illustrate the exemplary embodiment from FIG. 1. Furthermore, in FIGS. 3 to 5, the deflection 18 is in each case shown in the form of the offset O, which has a first direction 19. Furthermore, the guidance F resulting from the shape of the respective elongated hole 14 is shown, leading to a second direction 20. As can be seen, the first direction 19 always includes an angle α which is not zero with the second direction 20. If the elongated hole profiles are curved, the second direction 20 changes during the movement of the contact element 15.

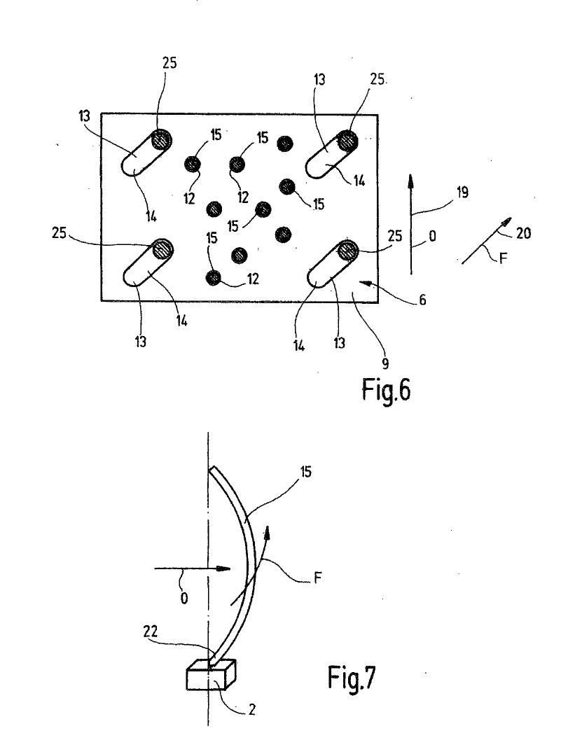

FIG. 6 shows a further exemplary embodiment of a contact-making apparatus 1 according to the invention, of which only the guide element 6, that is to say the guide plate 9 is illustrated. Otherwise, the design of the contact-making apparatus 1 shown in FIG. 6 corresponds to that in FIG. 1, so that reference is made to the statements there. In contrast to the exemplary embodiment shown in FIG. 1, the contact element 15 cannot be moved in an elongated hole 14, but the respective contact elements 15 pass, with only a small amount of play, through guideholes 12 in the guide plate 9, and are thus mounted there such that they can move longitudinally and can rotate. In order now to provide the second direction 20, which has been mentioned, for making contact with the unit under test 3, the entire guide element 6 can be moved laterally, in particular by having a plurality of guide sections 13 in the form of elongated holes 14, in which case the elongated holes 14 are identical and are arranged with their longitudinal extent in the same direction. Guide rods 25 which are fixed to the test head pass through the elongated holes 14 with a small amount of play. FIG. 6 shows straight elongated holes 14; however, it is also possible not to use a straight shape, but for example to use a curved or angled shape.

When contact is now made with the unit under test 2 in the exemplary embodiment shown in FIG. 6, the contact elements 15, which each have an offset O each exert a force on the guide element 6 during the contact-making process, such that the guide element 6 is deflected laterally, with the deflection direction being governed by the profile of the elongated holes 14. Since, in this case, the offset (first direction 19) and the corresponding guidance F resulting from the elongated holes 14 (second direction 20) once again also include an angle with one another which is not equal to zero, this results in a rotary movement of each contact element 15, leading to correspondingly good electrical contact being made with the unit under test 2.

The principle according to the invention is illustrated once again in FIG. 7. The figure shows a contact element 15 which is provided with an offset O and initially makes contact with a unit under test 2. If, in order to build up the full contact pressure, the unit under test 2 is now pressed more strongly against the contact element 15, then the pin guidance (F) which has been explained exerts a force on the deflected area whose direction differs from the direction of the offset, resulting in the deflected area effectively being moved like a crank, thus leading to a rotary movement of the contact tip 22 on the unit under test 2.

The invention accordingly consists in that the individual bent wires each carrying out a rotary movement, which they induce themselves, while contact is being made in order to reduce the contact resistance with the unit under test and/or in order to ensure a very good contact with the unit under test. The angle between the first direction 19 and the second direction 20 is preferably 45°. The rotary movement/rolling movement according to the invention of the contact, which has a circular cross section, while contact is being made results from the fact that it actually tries to bend out in the offset direction, but is forced in a different direction by the guidance. Embodiments are feasible in which the corresponding guidance may be banana-shaped, S-shaped, Z-shaped, etc. A corresponding direction change must always be carried out in order that the contact starts to roll and carries out the rotary movement. Even in the case of the exemplary embodiment in which the guidance is moved overall (exemplary embodiment shown in FIG. 6), correspondingly different refinements of the elongated holes can be provided, that is to say curved, banana-shaped, angled, S-shaped, Z-shaped, etc. It is also possible to carry out a kinematic reversal, that is to say the elongated holes 14 in the exemplary embodiment shown in FIG. 6 are located on the test head 3, while the guide rods 25 are arranged in a fixed position on the guide element 6.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. An electrical contact-making apparatus for testing electrical units, the apparatus comprising:
a guide element having at least one guide hole therein;
at least one contact element which operates on the bent-wire principle and which passes through the respective at least one guide hole, the contact element is guided in the respective guide hole such that the contact element can move axially and can rotate in the respective guide hole;
the contact element including an offset located along the length thereof, and the offset is in the form of a lateral deflection of the contact element, the deflection of the contact element points in at least one first direction;
the guide hole includes at least one guide section for the contact element and the guide section extends in at least one lateral, second direction to form with the first direction an included angle (α) that is not equal to zero.

2. An electrical contact-making apparatus for testing electrical units, comprising
at least one contact element which operates on the bent-wire principle;
at least one guide element operable for guiding axial and rotary motion of the contact element, whereby the contact element is guided such that it can move axially and can rotate in the at least one guide element;
the contact element including an offset located along the length thereof, and the offset is in the form of a lateral deflection of the contact element, the deflection of the contact element points in at least one first direction;
the guide element is moveable in at least one lateral, second direction to form with the first direction an included an angle (α) that is not equal to zero.

3. The electrical contact-making apparatus according to claim 2, wherein the guide element is moveable laterally by at least one guide section thereof.

4. The electrical contact-making apparatus according to claim 3, wherein the guide section runs in a straight line.

5. The electrical contact-making apparatus according to claim 3, wherein the guide section runs in the form of a curve.

6. The electrical contact-making apparatus according to claim 3, wherein the guide section runs in the form of an angle.

7. The electrical contact-making apparatus according to claim 2, wherein the lateral offset of the contact element comprises a natural bend of the contact element.

8. The electrical contact-making apparatus according to claim 2, wherein the contact element is operable such that the offset of the contact element is produced in the contact element by the influence of at least one of external lateral-force and axial force on the contact element.

9. The electrical contact-making apparatus according to claim 2, wherein the guide device includes at least two successive non-aligned guide holes through which the contact element passes, such that the offset of the contact element is produced by the non-aligned positions of the at least two guide holes.

10. The electrical contact-making apparatus according to claim 2, wherein the contact element has a first end which faces toward the electrical unit and has a second end away which faces away from the electrical unit;
the second end of the contact element which faces away from the electrical unit is mounted such that it cannot be moved axially with respect to the guide device but can rotate with respect to the guide device.

11. An electrical contact-making method for testing an electrical unit for use with an electrical contact making apparatus having at least one contact element which operates on the bent-wire principle and is mounted such that it can move axially and can rotate with respect to a guide device for the contact element, the contact element having an offset along the length of the contact element in the form of a lateral deflection which points in at least one first direction,
the method comprising guiding the contact element in the area of the deflection thereof by contacting an end of the contact element with an electrical unit, in a manner such that the deflection in the contact element is moved in a second direction that forms an included angle which is not equal to zero with respect to the first direction.

12. The electrical contact making apparatus according to claim 3, wherein the guide section is a hole in the guide device.

13. The electrical contact making apparatus according to claim 3, wherein the guide section does not run in a straight line.

14. The electrical contact-making apparatus according to claim 1, wherein the guide element is moveable laterally by at least one guide section thereof.

15. The electrical contact making apparatus according to claim 1, wherein the guide section does not run in a straight line.

16. The electrical contact-making apparatus according to claim 1, wherein the guide section runs in a straight line.

17. The electrical contact-making apparatus according to claim 1, wherein the guide section runs in the form of a curve.

18. The electrical contact-making apparatus according to claim 1, wherein the guide section runs in the form of an angle.

19. The electrical contact-making apparatus according to claim 1, wherein the lateral offset of the contact element comprises a natural bend of the contact element.

20. The electrical contact-making apparatus according to claim 1, wherein the contact element is operable such that the offset of the contact element is produced in the contact element by the influence of at least one of external lateral-force and axial force on the contact element.

21. The electrical contact-making apparatus according to claim 1, wherein the guide device includes at least two successive non-aligned guide holes through which the contact element passes, such that the offset of the contact element is produced by the non-aligned positions of the at least two guide holes.
